(19) United States
(12) Patent Application Publication
(10) Pub. No.: US 2019/0283182 A1
(43) Pub. Date: Sep. 19, 2019

(54) FREE FORM DEPOSITION

(71) Applicant: GKN Aerospace North America, Inc., Hazelwood, MO (US)

(72) Inventors: Aaron Thornton, Hazelwood, MO (US); William Henry, Hazelwood, MO (US); Mark Evers, Hazelwood, MO (US); Joseph Alaniz, Hazelwood, MO (US); Joshua Crews, Hazelwood, MO (US); Christopher Allison, Hazelwood, MO (US)

(21) Appl. No.: 15/922,100

(22) Filed: Mar. 15, 2018

(51) Int. Cl. B23K 26/342; B23K 26/082; B23K 26/12; B23K 26/14

(52) U.S. Cl. CPC B23K 26/342; B23K 26/1464; B23K 26/127; B23K 26/082

(57) ABSTRACT

An additive manufacture apparatus comprising a laser beam and wire supply system, wherein the laser beam and wire supply systems are movable with respect to a surface on which a component is to be built or a preceding weld bead, the laser beam and wire supply system being operable to create a plurality of weld beads and wherein at the end of forming one of said weld beads the weld supply system extends a length of wire and a nozzle forming the end of the wire supply system is simultaneously caused to retract away from the component being formed

### BACKGROUND

### Technical Field

The present disclosure relates to the field of additive manufacturing, and in particular to the ‘free-form’ additive manufacture process of LMD-w, also known as laser metal deposition with wire (LMD-w). Additive manufacturing processes involve building components by repeatedly laying down material in predetermined patterns to form the desired geometry of a component. Complex components can be manufactured in this way with no or minimal material wastage and additional machining

### Technical Background

The LMD-w (Laser Metal Deposition with wire) process is an additive manufacturing process which generally consists of a robotic arm, a laser, and a wire feed system.

The wire feed system provides the stock of material which is to form the component. The laser provides the means to melt the stock of wire and the robotic arm provides the means to form the component's geometry by moving the laser and feed system relative to the component being built.

The ‘build area’ or ‘work area’ (that is the area in which the part is built) is enclosed with a “tent” to trap inert gas inside. This prevents ambient gases interacting with the melting process and causing defects in the weld and component.

The component is formed or ‘built’ by melting a feed of wire using a laser beam within the inert atmosphere created by the inert gas ‘tent’. A weld pool is created and wire is fed into the pool. The laser beam and wire feeding system may be moved along a predetermined path to create a weld bead which, when cooled, forms a portion of the desired component. Repeatedly forming weld beads along predetermined paths allows a component shape to be formed. Robotic arms (or similar) may be conveniently used to follow pre-determined or pre-programmed paths. A component can thereby be formed.

At the end of each weld bead run the laser beam is deactivated and the robotic arm used to move the laser beam and wire feed system to the start position of the next weld bead. Another weld bead is then formed and the process repeated many times.

The wire feed system includes a guide nozzle through which the wire is supplied i.e. through which the wire extends towards the weld pool. Because the end of the wire is extremely hot and partially molten immediately after the end of a bead run there is a possibility that molten material may stick to the nozzle (or splash on the nozzle) causing nozzle damage or even nozzle blockage as the metal cools and hardens.

The present disclosure provides an enhanced additive manufacturing process which solves problems associated with nozzle damage and blockage.

### SUMMARY

In at least some examples, the present disclosure provides an apparatus and method to avoid damage and or blockage to a wire supply system for an LMD-w additive manufacture process.

Aspects of a disclosure are set out in the accompanying claims.

For example, according to one disclosure there is provided an additive manufacture apparatus comprising a laser beam and wire supply system, wherein the laser beam and wire supply systems are movable with respect to a surface on which a component is to be built or a preceding weld bead, the laser beam and wire supply system being operable to create a plurality of weld beads and wherein at the end of forming one of said weld beads the weld supply system extends a length of wire and a nozzle forming the end of the wire supply system is simultaneously caused to retract away from the component being formed.

According to another disclosure there is provided a method of operating an additive manufacturing apparatus as described herein.

Further aspects, features and advantages of the present technique will be apparent from the following description of examples, which is to be read in conjunction with the accompanying drawings.

The laser optic equipment may not move together with the wire deposition equipment or alternatively they may move together (by means of being coupled together). Advantageously decoupling the laser optics from the wire deposition apparatus or equipment allows the laser to be fixed and shielded from debris leaving the weld pool.

In a still further arrangement the laser optics and the wire deposition apparatus may be independently movable allowing for further optimisation of the process.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a schematic of a laser metal deposition with wire arrangement at an operating stage of wire extension and apparatus position;

FIG. 2 shows a schematic of a second stage of wire extension and apparatus movement according to the invention;

FIG. 3 shows a schematic of a third stage of wire extension and apparatus movement according to the invention; and

FIG. 4 shows a schematic of a robotic arm incorporating the invention.

### DESCRIPTION OF EXAMPLES

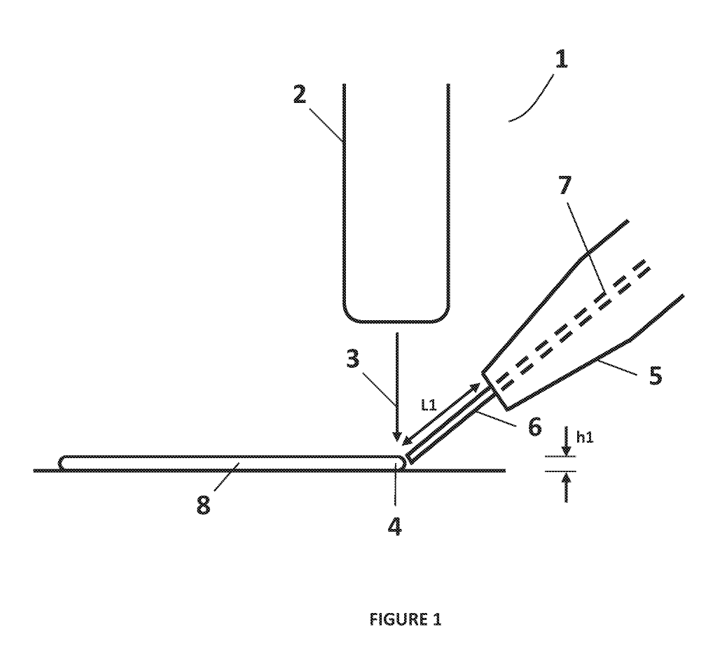

FIG. 1 shows a schematic of a laser metal deposition with wire arrangement in an operating state i.e. when welding is occurring.

As shown in FIG. 1 the arrangement 1 comprises a laser 2 which emits a laser beam 3 from a distal end of the laser. The laser and beam are directed towards a weld zone 4. The arrangement further comprises a wire feed system 5 which causes a stock of wire 6 to be discharged from a distal end of the wire feed system 5. The wire 6 may be any suitable material such as Ti-6A1-4V. Other suitable off the shelf wires may also be used.

The body of the wire feed system 5 comprises an internal passage 7 which is arranged to direct, or aim, the wire 6 towards a point that may intersect with the laser beam at the weld zone. More specifically, a small portion of the wire may happen to pass through the laser, but the laser may not actually melt the wire. The laser may be used instead to create a weld/melt pool into which the wire may be fed i.e. the weld pool is what melts the wire.

The wire itself may be driven out of the nozzle by a conventional wire supply apparatus as is known in the art (not shown).

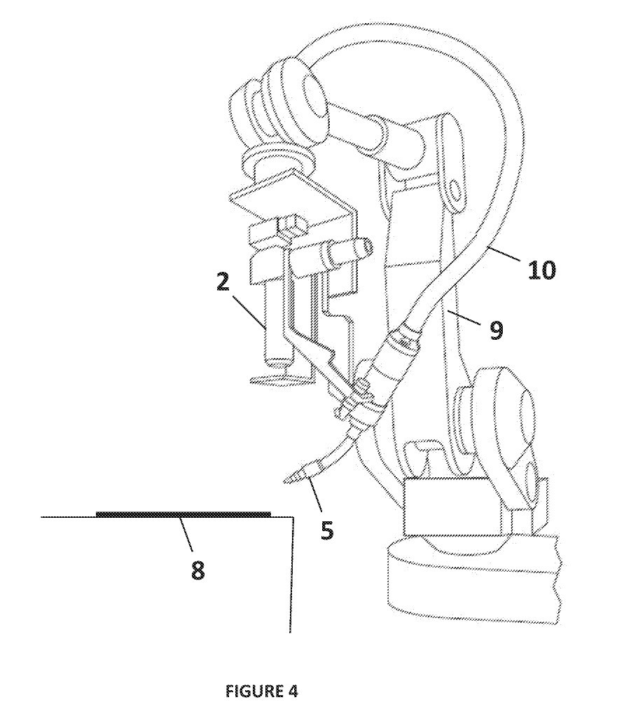

When the laser beam is activated and the wire feed system is also activated the laser causes wire at the weld zone 4 to melt creating a weld bead 8 (either by directly melting the wire or by introducing wire into the weld pool) The laser and the wire feed system may be coupled to one or more robotic arm(s) (shown in FIG. 4) such that they can be moved together (or independently) allowing the location of the weld zone 4 to be precisely controlled. The laser apparatus may equally be fixed and the laser light directed through suitable optics to heat the weld pool and/or wire.

Moving the robotic arm along a predetermined series of paths and activating the laser and the wire supply system allows repeated beads to be formed which cumulatively form a component's geometry.

Returning to FIG. 1, the two parameters h1 and L1 are shown. These parameters are:
h₁—the height of the weld zone above the preceding weld bead (or substrate for the first bead); and
L₁—the distance the wire extends from the wire supply nozzle

As discussed above, in one example the material being used currently is Ti-6A1-4V. This alloy requires an inert environment while molten or hot. The lasers being used are in the infrared spectrum and cannot be seen. The lasers have a pilot laser to assist with alignment and aiming. This pilot laser is in the visible light spectrum and is safe for close proximity

Again, in one example the motion system is a Kuka robot. The wire feed system uses a motor and a series of guide tubes to deliver the wire to the melt pool. The wire feeder can be turned off and on remotely. The speed of the wire can be adjusted remotely as well.

As discussed above, during deposition of wire into a melt pool, sometimes the wire can melt to the copper tip i.e. the distal end of the wire supply system 5. This copper tip helps deliver the wire to the desired location and is the last guide in a series of tubes. The copper tip is replaceable, but when the wire melts to the tip it usually solidifies and then faults the wire feeder. This can cause problems and significant delays when building a part.

This problem most often occurs at the end of an individual deposited bead. The end of the bead, especially when several layers up away from the substrate, tends to sag and deform. This sag can create droplets. These droplets increase the probability of melting to the copper tip. Other factors such as wire stick-out distance and distance from the copper tip to the melt pool can also significantly contribute

At the end of each weld bead the laser is deactivated and the robotic arm starts to move the laser and wire supply system to the start position of the next bead. This movement is commenced by moving the nozzle tip (which has the wire extending from it) away from the weld bead that has just been formed. Just before the wire feeder is pulled away, the copper tip is close to the melt pool.

The inventors have established that a solution to alleviate this problem is to pull the wire feeder out of the melt pool at an increased speed (i.e. moving the robot quickly or otherwise pulling with wire feeder away from the weld pool). During that movement the wire is pushed out very quickly to get the molten material away from the copper tip. At the end of each bead the wire may be clipped before the next bead is started. The drop of molten material is removed and the wire is clipped to a known repeatable distance.

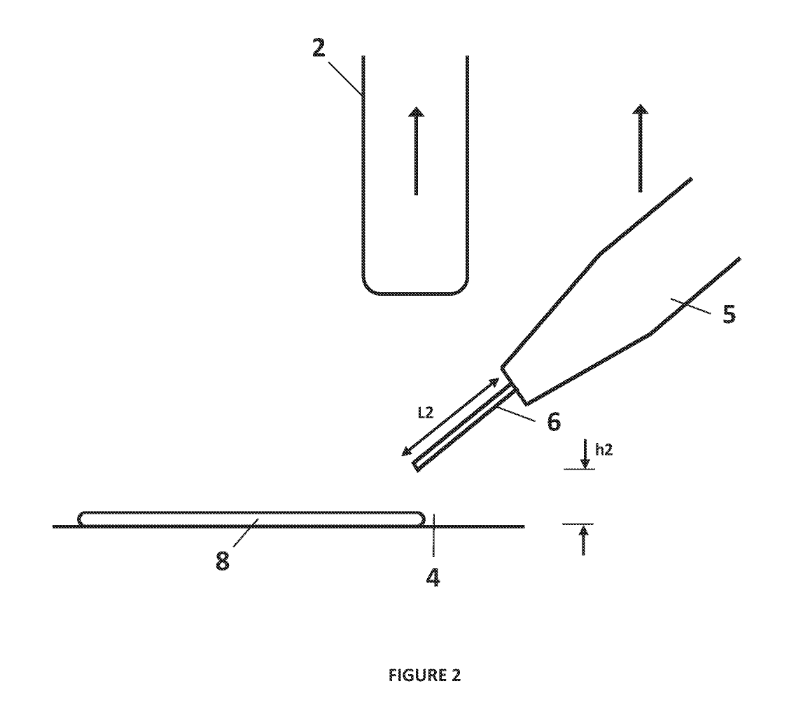

This is illustrated with reference to FIGS. 1 to 3 in which it can be seen that as the nozzle 5 moves away from the weld zone 4 (shown with reference to the arrow) the wire 6 is extended to a larger distance L₂ i.e. L₂>L₁.

Thus, as the nozzle 5 (and specifically the distal tip of the nozzle 5) is moved away from the weld zone the wire is simultaneously extended so that the hot molten end of the wire moves away from the end of the nozzle 5 (by a distance of L₂).

As shown parameter h has also increased such that h₂>h₁. This shows that the nozzle itself is moving away from the weld zone (in this example vertically awa).

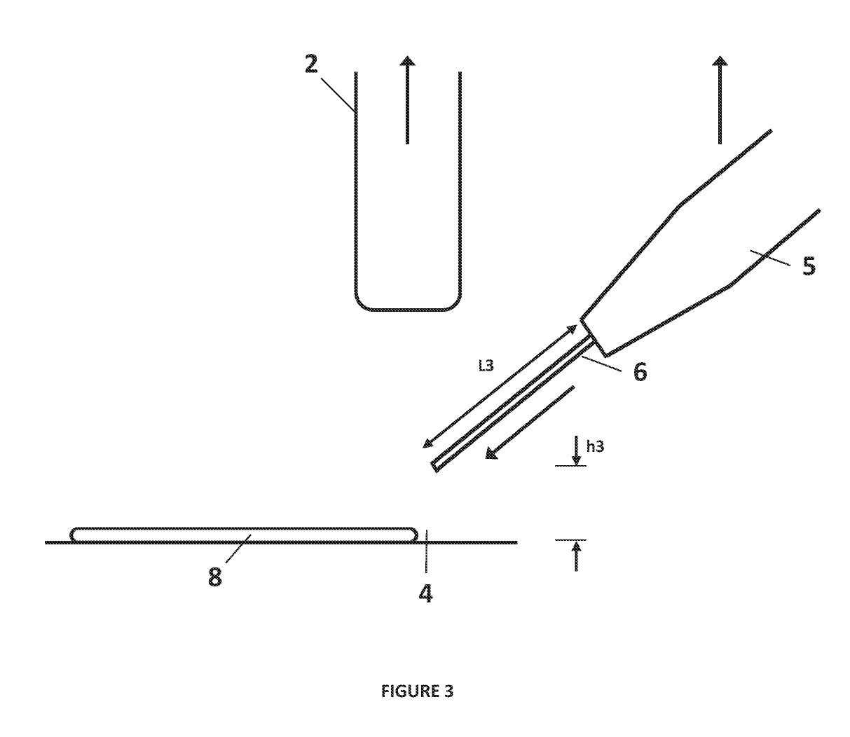

FIG. 3 shows the continued sequence where the nozzle 5 continues to move away from the weld zone 4 (parameter h increased to h₃ where h₃>h₂>h₁). Simultaneously the wire continues to extend to L₃ (where L₁<L₂<L₃).

Advantageously extending the wire whilst simultaneously moving the nozzle prevents the nozzle end being blocked and or damaged as a result of movement of the nozzle i.e. the hot molten end of the wire is moved away from the distal end of the nozzle 5 as the nozzle 5 is moved.

The parameters of movement in terms of speed of wire extension and speed of movement of the nozzle will depend on the specific material characteristics and welding conditions.

FIG. 4 illustrates a robot 9, supply of wire 10 and the laser and wire supply system 5 located at the movable head of the robot 9. A bead 8 can then be formed as described herein.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. An additive manufacture apparatus comprising a laser beam and wire supply system, wherein the laser beam and wire supply systems are movable with respect to a surface on which a component is to be built or a preceding weld bead, the laser beam and wire supply system being operable to create a plurality of weld beads and wherein at the end of forming one of said weld beads the weld supply system is configured to extend a length of wire and a nozzle forming the end of the wire supply system is simultaneously caused to retract away from the component being formed.

2. A method of operating an additive manufacturing apparatus as claimed in claim 1
